(19) United States
(12) Patent Application Publication
(10) Pub. No.: US 2007/0088236 A1
(43) Pub. Date: Apr. 19, 2007

(54) Inflatable massaging device for human neck and shoulder

(76) Inventor: Jimmy Tseng, Fairfax, VA (US)

Correspondence Address: Jimmy Tseng, 12643 Buckleys Gate Drive, Fairfax, VA, 22030, US

(21) Appl. No.: 11/249,835

(22) Filed: Oct. 14, 2005

(51) Int. Cl. A61H 9/00

(52) U.S. Cl. 601/151; 601/148; 601/DIG. 20

(57) ABSTRACT

An inflatable massaging device for human neck and shoulder, comprising mainly three open-ended ring-shaped air bladders and housings, adjacent two of the air bladders and housings being able to communicate with each other; hooks and loops to connect some of the open ends of the air bladders and housings; an air valve; an air pump; and a plurality of massage balls.

### FIELD OF THE INVENTION

This invention relates to an inflatable massaging device for human neck and shoulder, in particular to an inflatable massaging device for human neck and shoulder that can be controlled by the user.

### BACKGROUND OF THE INVENTION

Conventionally, people use an inflatable device which can consist of one or more inflatable bladders, and which can be put around the human neck and then inflated, so that the head can be pushed up and the burden (load) of the neck can be reduced.

The drawbacks of this conventional device is that it can not provide appropriate massage to the shoulder, and that each of the inflatable bladders must be inflated separately and thus it is time-consuming and in convenient.

Furthermore, the inflatable bladders can not be alternatively inflated and deflated without opening an air inlet valve thereof.

### SUMMARY OF THE INVENTION

An objective of the present invention is to provide an inflatable massaging device for human neck and shoulder, which is comprised mainly of, preferably, three inflatable air bladders, wherein each two adjacent ones of the three air bladders can communicate. With each other and thus only one air inlet valve is needed.

Another objective of the present invention is to provide an inflatable massaging device wherein, on the lower surface thereof, a plurality of massage balls are provided, so as to massage the shoulder.

### BRIEF DESCRIPTION OF THE DRAWINGS

FIG. 1 is a perspective schematic view showing a preferred embodiment of the inflatable massaging device of the present invention;

FIG. 2 is a perspective view of an upper air bladder and housing of the inflatable massaging device;

FIG. 3 is a perspective view of a middle air bladder and housing of the inflatable massaging device;

FIG. 4 is a perspective view of a lower air bladder and housing of the inflatable massaging device;

FIG. 5 is a top view of FIG. 2;

FIG. 6 is a bottom view of FIG. 2;

FIG. 7 is a top view of FIG. 3;

FIG. 8 is a bottom view of FIG. 3;

FIG. 9 is a top view of FIG. 4;

FIG. 10 is a bottom view of FIG. 4;

FIG. 11 is a perspective view of the inflatable massaging device, with a portion cut off to show the inside of the bladders;

FIG. 12 is another perspective view of the inflatable massaging device, showing an air tube for inflation;

FIGS. 13 and 14 illustrate how to put the inflatable massaging device around the neck;

FIGS. 15 and 16 are side views showing the inflatable massaging device in an inflated position;

FIGS. 17 and 18 are front view and rear view, respectively, showing the inflatable massaging device in an inflated position;

FIG. 19 shows a front view depicting a hand controlling the inflation and deflation;

FIG. 20 shows an example of inflating means (air pump) employed with the device;

FIG. 21 shows a perspective view of air pump used in the present invention;

FIG. 22 shows a perspective view of a portion of the air pump shown in FIG. 21;

FIG. 23 is a perspective view similar to FIG. 22, looking from a difference angle;

FIG. 24 is a top view of the parts shown in FIG. 22;

FIG. 25 is an exploded view of the parts shown in FIG. 22;

FIG. 26 is a longitudinal sectional view of the parts shown in FIG. 22;

FIG. 27 is a top view of the air pump, with a cover installed;

FIG. 28 is a bottom view of the air pump;

FIG. 29 is a schematic view depicting the hand and the air pump;

FIG. 30 is a similar to FIG. 29, showing different angle;

FIG. 31 is a perspective view of the air valve that can be used on the inflatable massaging device;

FIG. 32 is similar to FIG. 31, with a lid closed the air valve;

FIG. 33 is an exploded view of the air valve; and

FIG. 34 is a longitudinal sectional view of the air valve, without showing the lid.

### DETAILED DESCRIPTION OF THE INVENTION

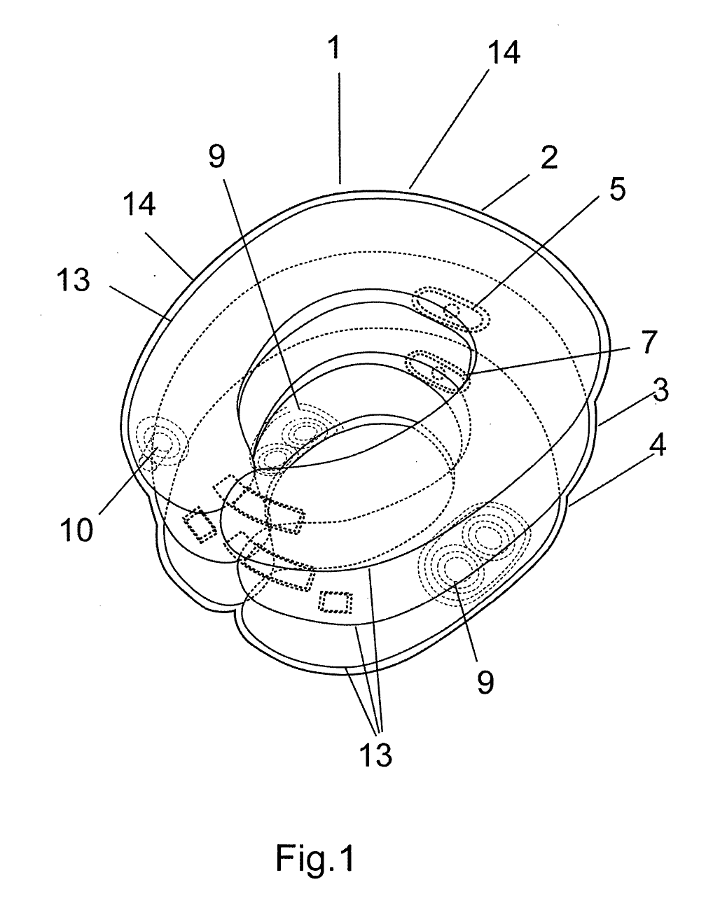

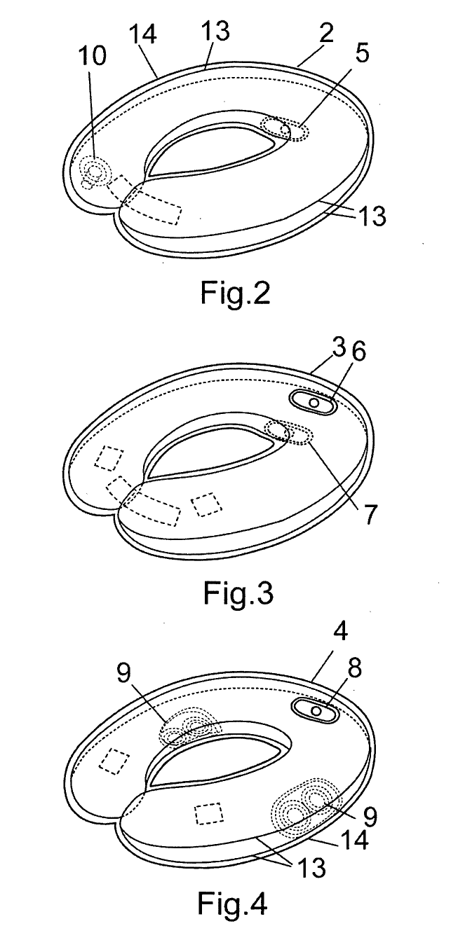

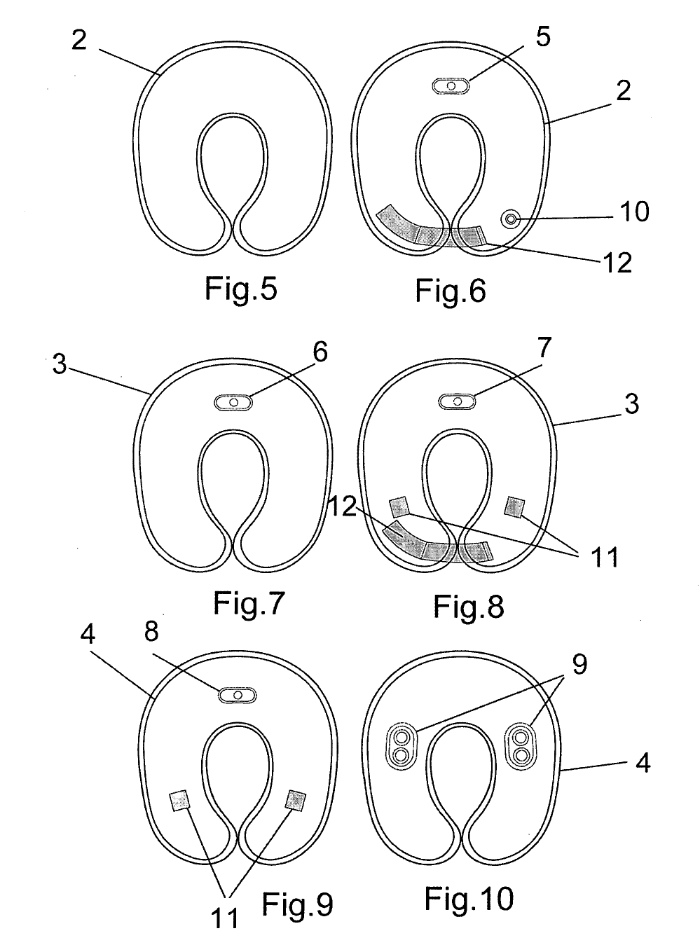

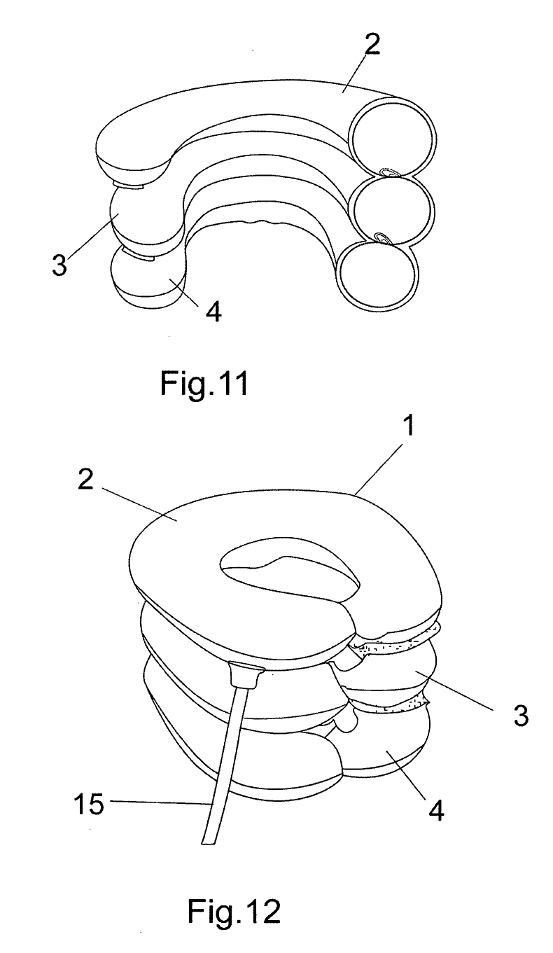

Please see FIGS. 1-12 for the description of the structure of a preferred embodiment of the inflatable massaging device for human neck and shoulder. Designating numeral 1 generally indicates the inflatable massaging device. The inflatable massaging device 1 is comprised mainly of an upper air bladder and housing (shell) 2, a middle air bladder and housing 3, and a lower air bladder and housing 4. Each of the air bladders and housings has an air bladder 13 and housing (shell) 14. As shown in FIGS. 1, 2 and 6, the lower side of the upper air bladder and housing 2 is provided with an air valve 10. From FIGS. 5-10, we can see an air communication hole 5 is provided on the lower side of the upper air bladder and housing 2, which is aligned with and communicates with an air communication hole 6 provided on the upper side of the middle air bladder and housing 3. Likewise, an air communication hole 7 is provided on the lower side of the middle air bladder and housing 3, which is aligned with and communicates with an air communication hole 8 provided on the upper side of the lower air bladder and housing 4.

Hooks and loops (Velcros) 12 are provided on the lower side of the upper air bladder and housing 2 for adjusting the degree of opening of open ends of the upper air bladder and housing 2. Likewise, hooks and loops (Velcros) 12 are provided on the lower side of the middle air bladder and housing 3 for adjusting the degree of opening of open ends of the middle air bladder and housing 3. Preferably, the distance between the front edge of the neck of the user and the inner sides of the front positions of the upper air bladder and housing 2 and the middle air bladder and housing 3 is about the same as the width of 2 to 3 fingers before the inflatable massaging device 1 is inflated.

Hooks and loops (Velcro) 11 are also provided on the lower side of the middle air bladder and housing 3 and the upper side of the lower air bladder and housing 4, so that they can be attached together and the relative position between them can be adjusted to enhance comfortableness.

A plurality of massage balls 9 are provided on the lower side of the lower air bladder and housing 4 and are positioned at places corresponding to some pressure points on the shoulder so that when the inflatable massaging device 1 is fully inflated, the massage balls 9 can stimulate those pressure points.

An inflation tube is connected at one end to the air valve 10, and at the other end to an inflation means (air pump).

The housing (shell) 14 is made of soft fabric or other suitable material. The air bladder 13 is made of soft PVC (poly vinyl chloride), TPU (thermoplastic polyurethane), PU (polyurethane), or other suitable material.

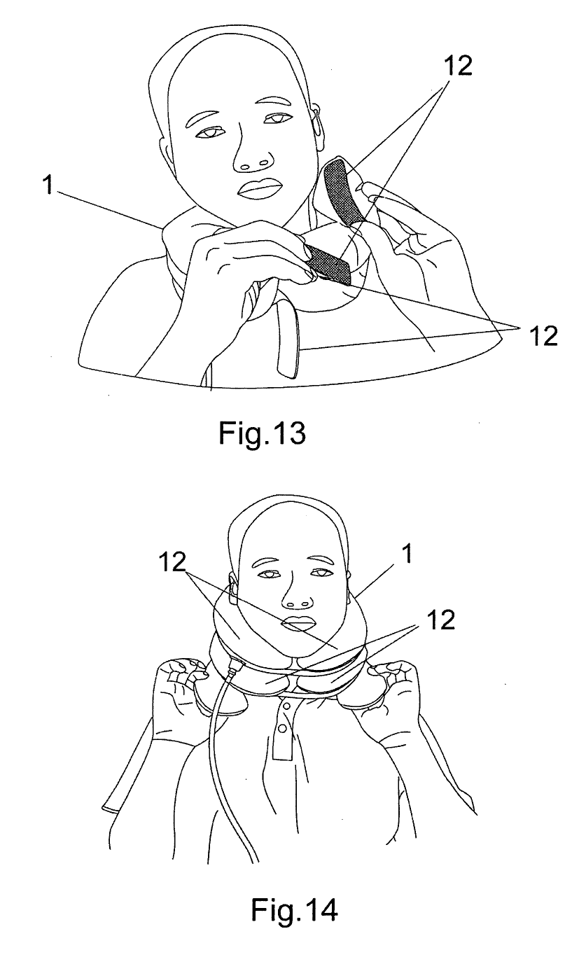

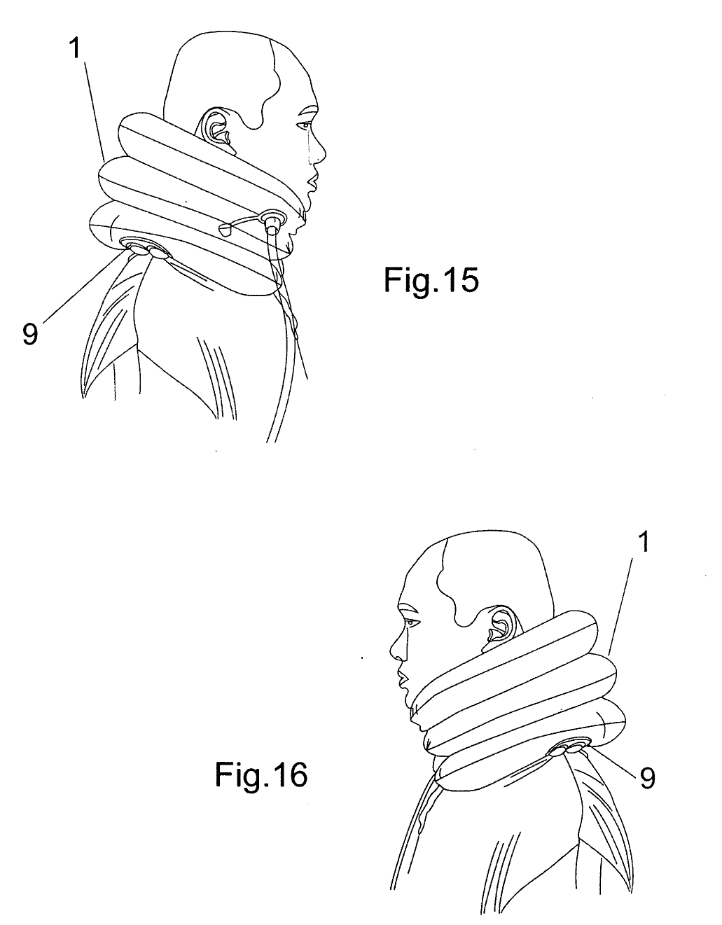

FIGS. 13 and 14 illustrate how to put the inflatable massaging device 1 around the neck. As mentioned hereinabove, preferably, the distance between the front edge of the neck of the user and the inner side of the front portions of the upper air bladder and housing 2 and the middle air bladder and housing 3 is about the same as the width of 2 to 3 fingers before the inflatable massaging device 1 is inflated.

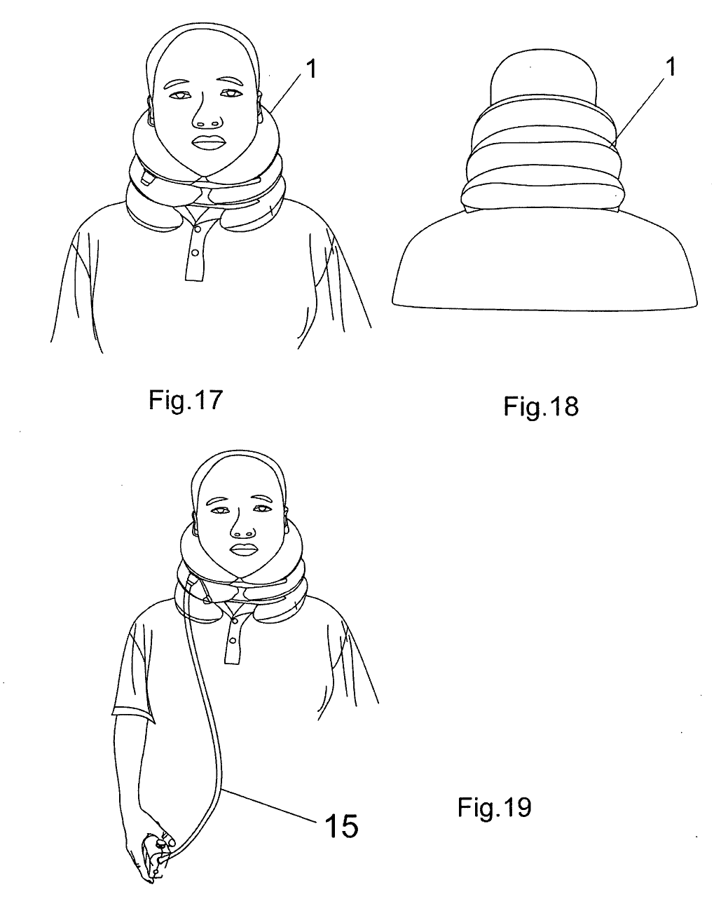

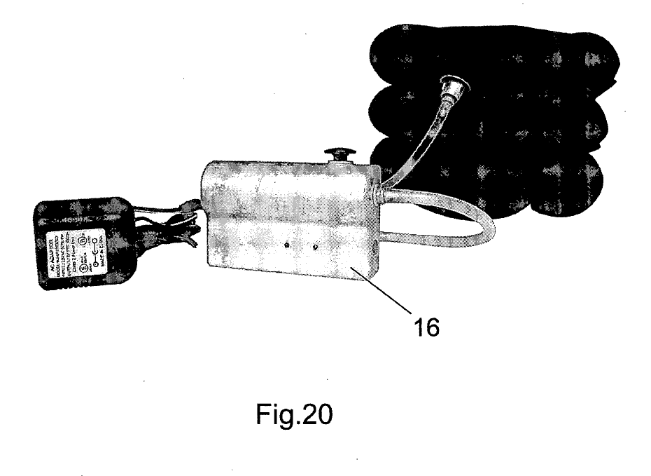

The material of the air bladders 13 of the upper air bladder and housing 2 and the lower air bladder and housing 4 is relatively softer than that of the middle air bladder and housing 3 so that, as seen from FIGS. 15-18, the upper edge of the upper air bladder and housing 2 can closely contact the lower cheek and rear head of the user, and the lower edge of the lower air bladder and housing 4 can closely contact the shoulder of the user, and the relative movement between the inflatable massaging device 1 and the shoulder of the user can be minimized after the inflatable massaging device 1 is fully inflated.

The inflatable massaging device 1 of the present invention can also be used on the car, using the power source on the car if the user wants to do so.

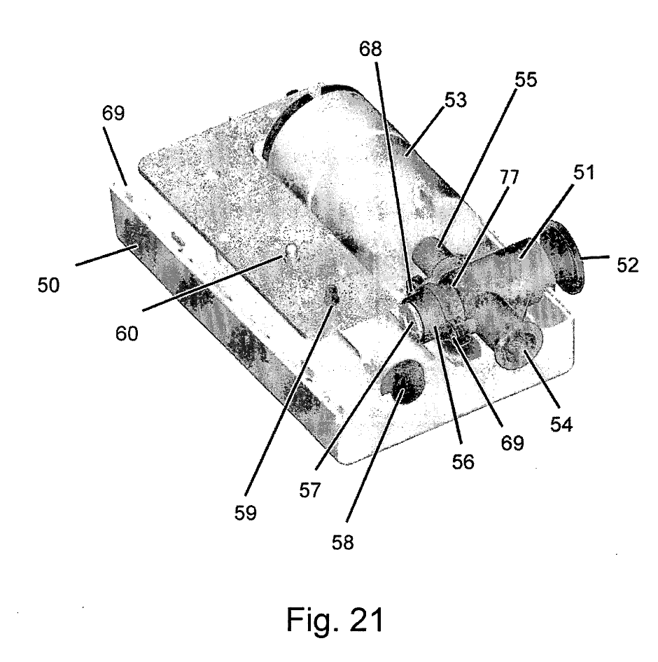

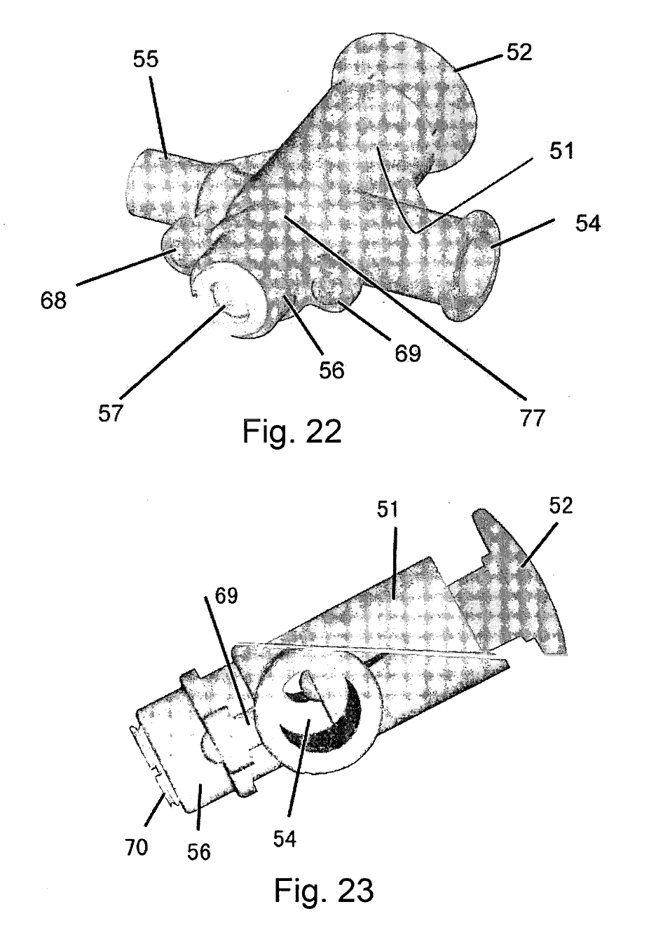

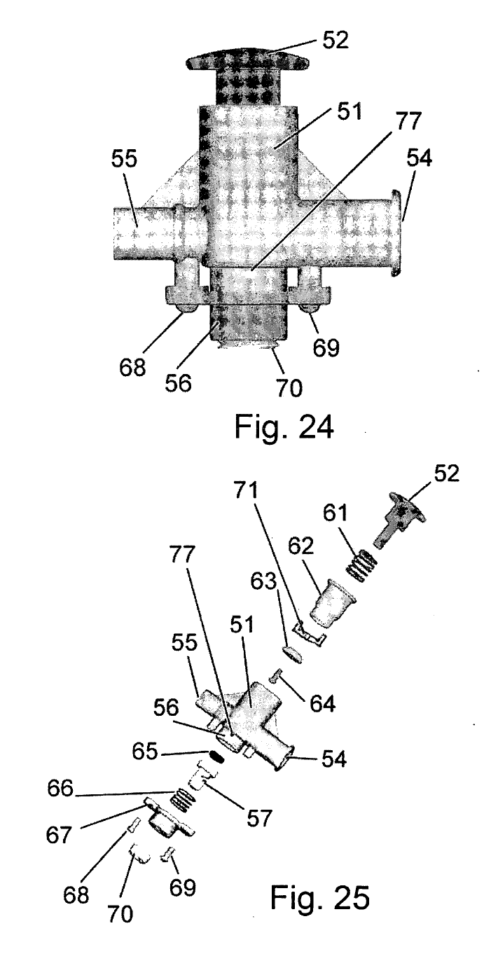

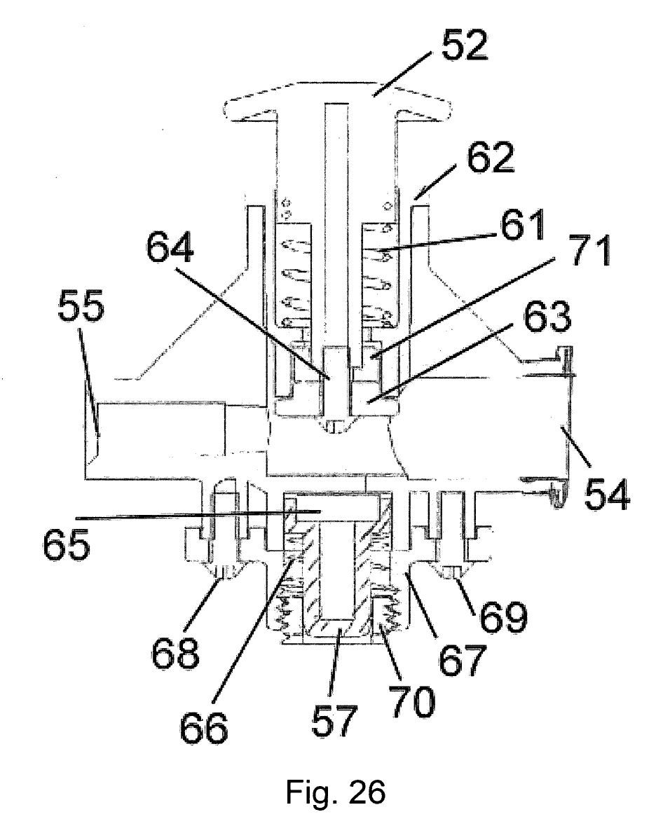

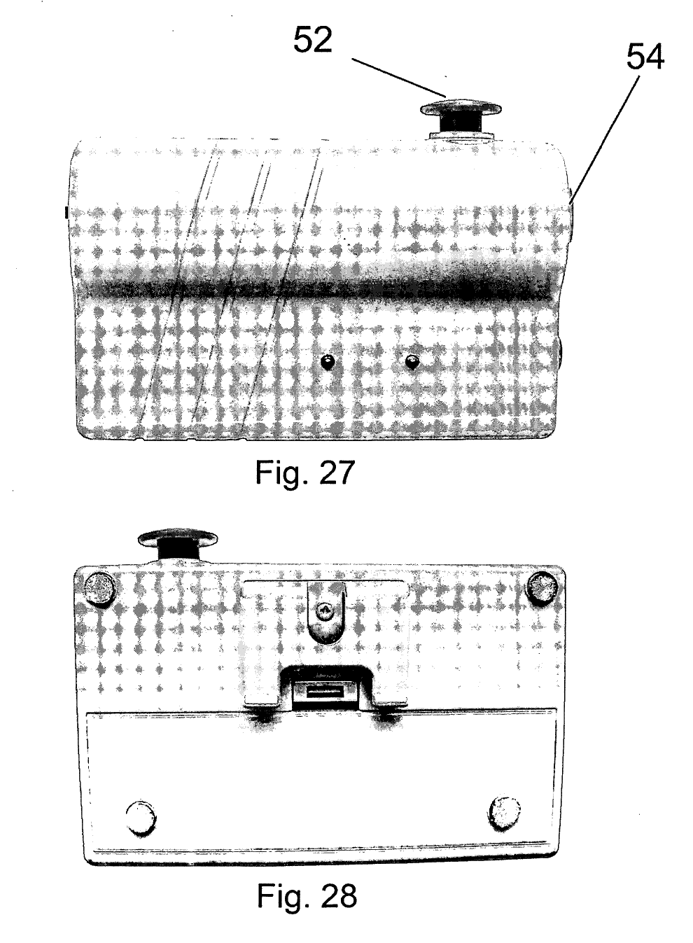

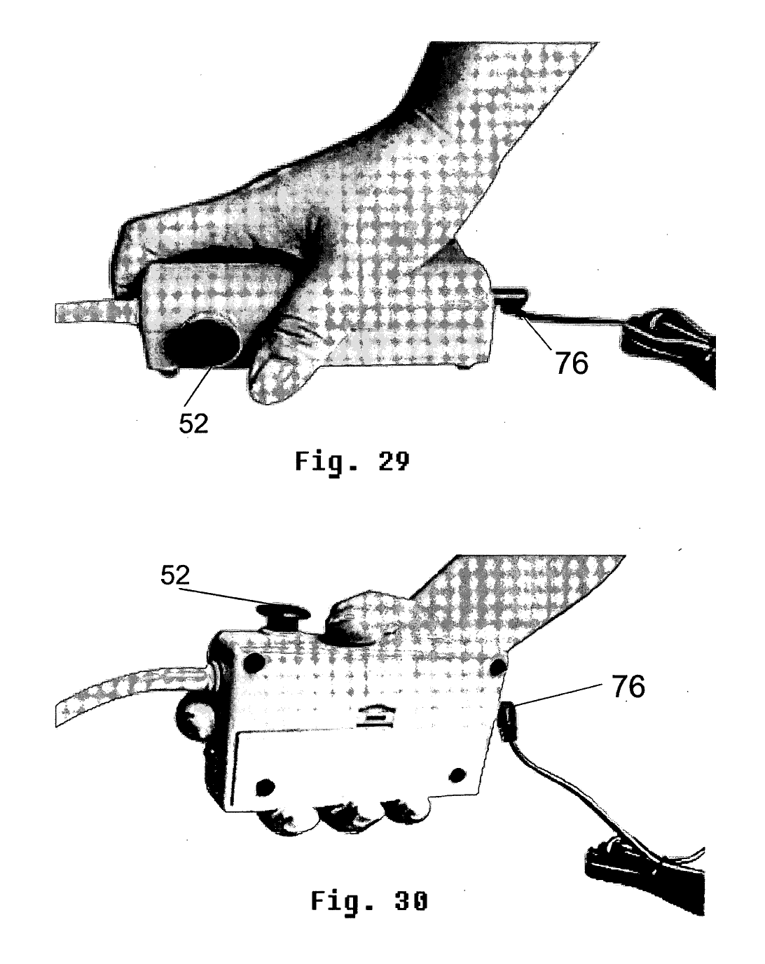

Please see FIGS. 21-26 for the detailed structure of the air pump 50. The air pump 50 comprises mainly a discharge valve button 52, a safety valve plunger 57, a pipe 51 for accommodating the discharge valve button 52 and relevant parts, a second pipe 56 for accommodating the safety valve plunger 57 and relevant parts, a pumping device 53, a pipe 55 in communicating with the pumping device 53, a pipe 54 for accommodating an end of an air tube having another end connected to the air valve of the inflatable massaging device of the present invention, and a starting button 58.

The discharge valve has the button 52, a spring 61, a socket 62, a fixation element 71, a piston 63, and a bolt 64 for fastening the button 52, the fixation element 71, and the piston 63 together, when the button 52 is pushed down, the piston 63, the fixation member 71 and the bolt 64 are pushed down simultaneously, and air can be discharged from an air release hole 77.

The safety valve has the plunger 57, a piston 65, a spring 66, a stopper 67, a micro-adjustment member 70, and two bolts 68 and 69 for fastening the stopper 67 to the pipes 54 and 55. The micro-adjustment member 70 and the stopper 67 have corresponding threads so that the member 70 can be rotated to adjust and set safety pressure which is preferably 0.015 MPA (mega Pascal). When the air pressure in the air tube or pipe 54 is more than the set value, the plunger 57 and the piston 65 is pushed downward by the air pressure and excessive air can be discharged from the air release hole 77.

Indicating light 59 indicates the inflation of the air pump 50, indicating light 60 indicates that the power is “on”, A switch 72 is provided on the housing of the air pump 50, A socket 73 is also provided on the housing of the air pump 50 for the insertion of a plug (line) 76 of an adapter (ac/dc converter), A clip (or hook) 74 is provided on the housing of the air pump 50 for attaching the air pump 50 on a belt or pocket of the user. A battery compartment 75 is also provided on the housing for accommodating batteries.

When the user's hand (finger, preferably forefinger) pushes down the starting button 58, the pumping device 53 is energized to provide air to the air valve on the inflatable massaging device of the present invention through the pipes 53 and 54, and an air tube (not shown in the drawings), and thus the inflatable massaging device is inflated when the user's hand (finger, preferably thumb) pushes down the safety valve plunger 57, air from the inflatable massaging device is discharged at air release hole 77 through the air valve, air tube, and the pipe 54, and thus the inflatable massaging device can be deflated.

In actual use, the user can choose one of the following three ways, or other suitable ways;
1. Push and release: the user continuously inflate the inflatable massaging device until the user can not tolerate, then deflate the same, then inflate and deflate it alternatively;
2. Continuous inflation: the user inflate the inflatable massaging device fully, then discharge about half of the air in that device, and then inflate it fully again. These steps can be repeatedly done.
3. Full inflation and full release: the user inflate the inflatable massaging device fully, then turn off the air pump 50, let the air stay in the inflatable massaging device for a while (eg. 3-5 minutes), then deflate the inflatable massage device. These steps can be repeatedly done.

The purpose of alternatively inflating and deflating the inflatable massaging device is to exert pressure to the user's body part so as to massage it and stimulate pressure points; then let the body part relaxed when it is deflated.

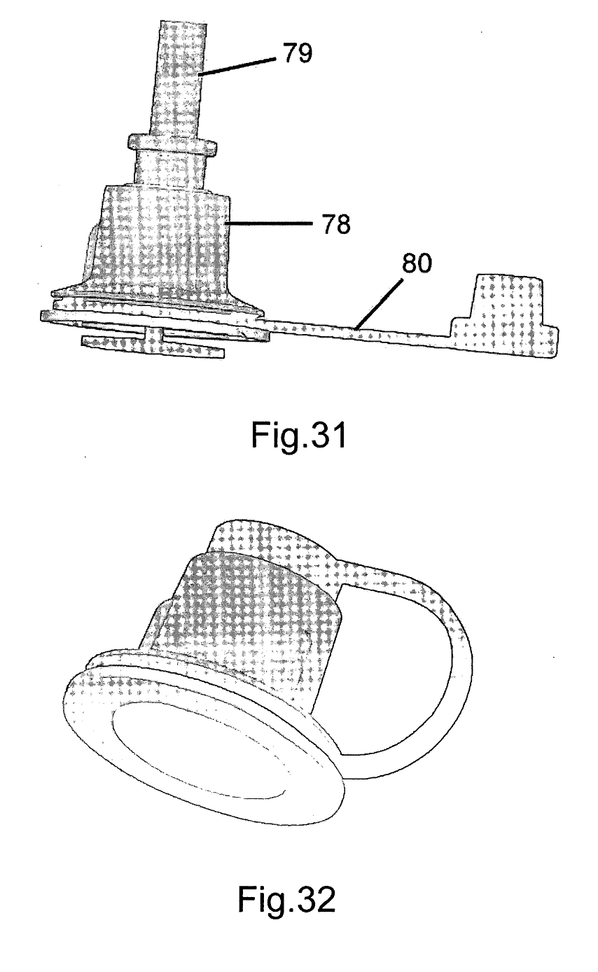

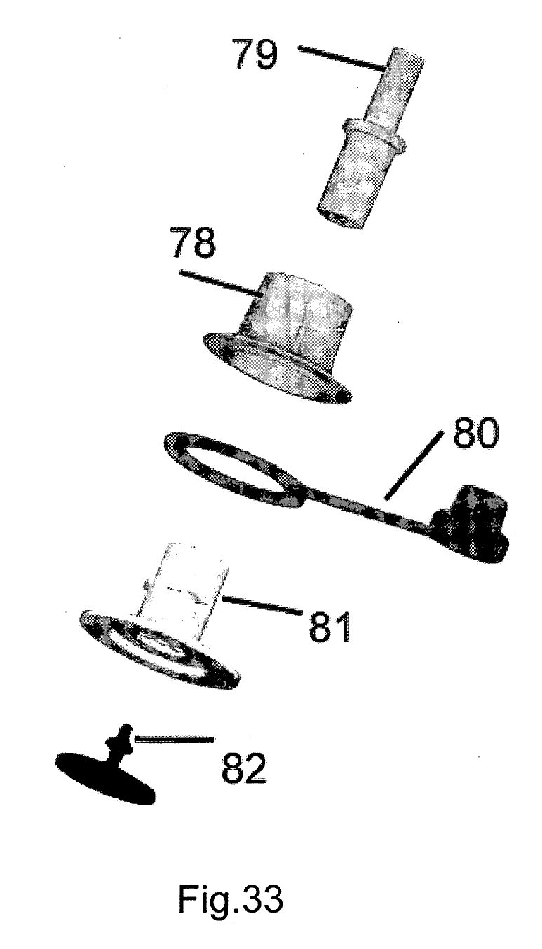

Please see FIGS. 31-34 for the detailed structure of the air valve, the air valve includes a housing 78, an inner element 81, a connecting element 79, a stopper 82, and a lid 80.

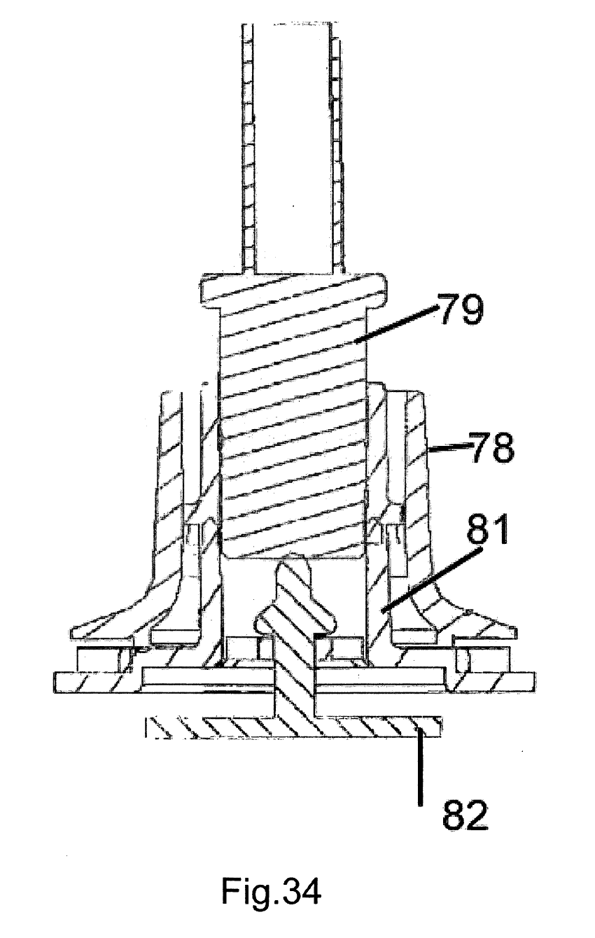

When the connecting element 79 is inserted into the inner element 81, it pushes down the stopper 82 and thus air can go from the air pump 50, an air tube (not shown in the drawings) which is inserted into the upper and of the connecting element 79, the connecting element 79, the gap between the stopper 82 and the inner element 81, and enter the inflatable massaging device of the present invention. (as shown in FIG. 34). When the connecting element 79 is removed from the air valve, the air pressure in the inflatable massaging device pushes the stopper 82 into a closed position. At this time, the lid 80 can be put on to help preventing the leakage of the air from the inflatable massaging device.

The advantage of this structure is that, at this status, the user can move around freely without the need of carrying the air pump 50.

When the user wants to release the air from the inflatable massaging device, a piece of stick or rod similar to the connecting element 79 can be inserted into the inner element 81 to push down the stopper 82 so that the air can be released.

1. An inflatable massaging device for human neck and shoulder, comprising mainly and upper air bladder and housing having opening ends; a middle air bladder and housing having opening ends; a lower air bladder and housing having opening ends; an air valve; an air pump; a first sets of hooks and loops provided on the opening ends of the upper air bladder and housing; a second sets of hooks and loops provided on the opening ends of the middle air bladder and housing; a third sets of hooks and loops provided on the lower side of the middle air bladder and housing and the upper side of the lower air bladder and housing; and a plurality of massage balls provided on the lower side of the lower air bladder and housing; wherein the lower side of the upper air bladder and housing can communicate with the upper side of the middle air bladder and housing; the lower side of the middle air bladder and housing can communicate with the upper side of the lower air bladder and housing.

2. The inflatable massaging device as in claim 1, wherein the upper air bladder and housing and the lower air bladder and housing are made of materials relatively softer than that of the middle air bladder and housing.

3. The inflatable massaging device as in claim 1, wherein the air pump comprises mainly a housing, a safety valve, a discharge valve, a pumping device, a starting button, and indicating lights.

4. The inflatable massaging device as in claim A, wherein the safety valve includes a plunger, a piston, a spring, a stopper, a micro-adjustment member, and two bolts.

5. The inflatable massaging device as in claim A, wherein the discharge valve includes a button, a spring, a socket, a fixation element, a piston, and a bolt.

6. The inflatable massaging device as in claim 1, wherein is the air valve comprises a connecting element, a housing, an inner element, a lid, and a stopper.
